(19) United States
(12) Patent Application Publication
(10) Pub. No.: US 2022/0122276 A1
(43) Pub. Date: Apr. 21, 2022

(54) FORENSIC CERTIFICATION OF ARTWORK

(71) Applicants: Peter KARAM, Providenciales (TC); Ardavan TAJBAKHSH, St. Philip (BB); Michael BARETT, Kingston (CA)

(72) Inventors: Peter KARAM, Providenciales (TC); Ardavan TAJBAKHSH, St. Philip (BB); Michael Barrett, Kingston (CA)

(21) Appl. No.: 17/507,071

(22) Filed: Oct. 21, 2021

Related U.S. Application Data
(60) Provisional application No. 63/094,615, filed on Oct. 21, 2020.

(51) Int. Cl. G06T 7/33; G06Q 30/00; G06T 7/564; G06T 7/529

(52) U.S. Cl. CPC G06T 7/33; G06Q 30/0185; G06T 2207/10028; G06T 7/529; G06T 2207/20116; G06T 7/564

(57) ABSTRACT

A computer-implemented method for authenticating artwork comprises obtaining identifying information for a target artwork, including at least an artwork identifier and dimensions and determining a set of target surface regions and coordinate information identifying and locating each target surface region relative to the overall surface. A three-dimensional topographical image of each surface region is obtained and stored so that the coordinate information and the topographical images are associated with the artwork identifier and each topographical image is associated with corresponding coordinate information. For authenticating questioned artwork purporting to be the target artwork, the coordinate information for the target artwork is used to obtain a three-dimensional topographical image of questioned surface regions corresponding in location to corresponding target surface regions of the target artwork. Each three-dimensional topographical image of a questioned surface region is compared to a three-dimensional topographical image of a correspondingly located target surface image on the target artwork.

### TECHNICAL FIELD

The present disclosure relates to forgery detection and in particular to the detection of forged artworks.

### BACKGROUND

There are always people who are unconstrained by morality and will seek to profit by deceiving others. Forgery is one example of such activity.

Forgeries have been around for centuries and range from clumsy copies to intricate replicas. Where an item such as a painting, sculpture, archaeological artefact or valuable collectible is being sold, has been recovered after loss or theft, or is being loaned to (or returned from) another institution, because of the often substantial value of the item, and the risk that a forgery might be substituted, there is a need for a reliable technique for detecting such forgeries. In addition, an artist may wish to have some method by which her or his work can be authenticated at or before the first sale, in order to guard against future forgeries.

There are a number of known techniques which have been used in an attempt to detect forgeries. Conventionally, such techniques rely on some of the chemical or physical attributes of the object to be identified.

For example, where the object at issue is a painting, if a specific pigment was used that was not available during the artist's lifetime, then one can conclude that the artwork being examined is a forgery. Another commonly used method is radiography. This technique can detect if there are areas in a questioned painting that have been repainted or if the artist's work has been painted over. In either case, the analysis is complicated and requires protracted effort, often involving several art experts who come to a conclusion and pronounce a given painting to be an original.

A true master forger would likely carry out (and master forgers have in fact carried out) extensive research into the types of paints and pigments that were available at the time of the creation of the painting that is intended to be reproduced, and would use only those types of paints and pigments. If such a forger had access to detailed photographs of the work he is forging, he would be able to mimic not only the colours and layouts of a masterpiece, but even the style and direction of individual brushstrokes. However, no matter how skilled the forger, there will still be certain aspects of an original painting that could not be precisely duplicated. For example, the forger would be using different brushes than those used by the original author, and even if brush size and brushstroke direction were matched, there would be differences in the number, position and thickness of individual bristles, and the thickness of paint that is deposited, even if the exact same brush were to be used, resulting in detectable differences between the original work and the forgery.

U.S. Patent Application Publication No. 20060269896, entitled “High speed 3D scanner and uses thereof”, proposes an approach to the verification of art. According to this proposal, a work of art such as a painting or a sculpture, or a portion of such a work of art, is scanned to create a three dimensional model of the work or portion thereof, which is then stored in a suitable memory. Then, upon the appearance of a piece of art (a “questioned work”) purporting to be a work which has already been so scanned (a “known work”), the questioned work can be scanned, and the scan compared to the scan for the known work as a means of identification. U.S. Patent Application Publication No. 20060269896 suggests the use of a laser in the 1310-1550 nm range to perform the scanning, and also proposes the development of a large database of scans from known works, such as the contents of one or more museums.

However, the approach proposed in U.S. Patent Application Publication No. 20060269896 fails to account for the substantial amount of data storage required for a sufficiently detailed 3-dimensional topographical map of a painting of significant size, other than to suggest that only a portion of the work might be scanned. In addition, U.S. Patent Application Publication No. 20060269896 fails to account for the possibility that even minor variations in atmospheric conditions, such as temperature and humidity, could result in disruptions in the surface of a painting between scans sufficient to frustrate comparison.

### SUMMARY

According to an aspect of the present disclosure, disclosed is a computer-implemented method for authenticating an artwork, comprising: obtaining identifying information for the artwork, the identifying information including at least an artwork identifier and dimensions of the artwork; determining a set of target surface regions, each target surface region being a portion of an overall surface of the artwork, and coordinate (positioning) information identifying and locating each target surface region relative to the overall surface; obtaining a three-dimensional topographical image of each target surface region; and storing the identifying information, the coordinate (positioning) information and the topographical images so that the coordinate (positioning) information and the topographical images are associated with the artwork identifier and each topographical image is associated with its corresponding coordinate (positioning) information. The set of target surface regions may be generated randomly, or may be the result of using a formula to assess which portions of an artwork should be scanned based on a set of criteria, such as size. The three-dimensional topographical image of each surface region may be obtained using an interferometer.

According to another aspect of the present disclosure, disclosed is a computer-implemented method for authenticating an artwork, comprising: providing a questioned artwork purporting to be a target artwork; retrieving from a storage, for the target artwork, coordinate information identifying and locating each of a plurality of target surface regions of an overall surface of the target artwork; and using the coordinate information to obtain a three-dimensional topographical image of a plurality of questioned surface regions of an overall surface of the questioned artwork, each questioned surface region corresponding in its location on the overall surface of the questioned artwork to a location of a corresponding one of the target surface regions of an overall surface of the target artwork.

According to another aspect of the present disclosure, each three-dimensional topographical image of a questioned surface region is compared to a three-dimensional topographical image of a correspondingly located target surface image on a target (reference) artwork.

### BRIEF DESCRIPTION OF THE DRAWINGS

In order that the subject matter may be readily understood, embodiments are illustrated by way of examples in the accompanying drawings, in which:

FIG. 1 is a perspective view of an illustrative imaging system for authenticating an artwork, according to an aspect of the present disclosure;

FIG. 2 is a front plan view of an illustrative imaging system for authenticating an artwork, according to an aspect of the present disclosure;

FIG. 3 is a side plan view of an illustrative imaging system for authenticating an artwork, according to an aspect of the present disclosure;

FIG. 4A is a top plan view of an illustrative elevator, according to an aspect of the present disclosure;

FIG. 4B is a side perspective view of an illustrative elevator with a tubing, according to an aspect of the present disclosure;

FIG. 5 is a flow chart showing an illustrative method of authenticating an artwork using the artwork authentication system, according to an aspect of the present disclosure;

FIG. 5A is a schematic representation of a questioned artwork and a target artwork showing selected regions thereof;

FIG. 5B and FIG. 5C show, respectively, a top plan view and top perspective view of an illustrative three-dimensional topographical image of a target surface region of an illustrative sample painting;

FIG. 6 is a flow chart showing an illustrative method of authenticating an artwork using the artwork authentication system, according to an aspect of the present disclosure;

FIG. 7 is a flow chart showing an illustrative method for comparing questioned artwork image data to target artwork image data for a particular target artwork, according to an aspect of the present disclosure;

FIG. 8 is a flow chart showing an illustrative method for determining the best rotational match score for a given rotational position of an image of a questioned artwork relative to a target artwork image, according to an aspect of the present disclosure;

FIG. 9 is a block diagram showing an illustrative computer system in respect of which aspects of the present disclosure may be implemented; and

FIG. 10 is a block diagram showing an illustrative smartphone in respect of which aspects of the present disclosure may be implemented.

### DETAILED DESCRIPTION

Described herein is a computer-implemented method and system for authenticating an artwork.

The term “artwork”, as used herein, includes paintings, drawings, sculptures and other works of art that are unique by having been created once by a human artist (or possibly non-human animal artist, such as a painting by an elephant). Such artworks will have unique features associated with their method of creation, such as brushstroke features based on the number, position direction and thickness of individual bristles, and the thickness of paint that is deposited; these could not be precisely reproduced even by the same artist attempting the most faithful possible reproduction using the same paint and brushes. The term “artwork” also includes works which, while originally produced in some volume and being intended to be identical, may have become valuable over time and hence worthy of authentication. Examples of the latter include paper currency, sports cards (e.g. baseball, hockey and basketball) and other collectible cards, books, comic books, or other paper goods, including the cardboard packaging of a toy such as an action figure or other collectible item that remains sealed in its package. Here, too, even despite attempts at faithful reproduction, there will be microscopically detectable unique features of each such piece, including topographical features of the individual pieces of paper or cardboard and the features associated with the deposition of ink, paint or the like. Thus, the term “artwork” as used herein is intended to have a broad and expansive meaning.

The System

FIG. 1 shows a perspective view of one embodiment of an aspect of an artwork authentication system 100 for authenticating an artwork such as a painting. The artwork authentication system 100 comprises a tabletop 104 with a substantially flat (planar) surface. The tabletop 104 is rectangular having two parallel relatively long sides 105 and two parallel relatively short sides 107. The tabletop 104 is for supporting an artwork to be authenticated. In some embodiments, a commercially available table may be sufficient, in other applications the table may be a bespoke table meeting specific criteria for construction, stability, to have a variable work space, an open framework, and so on. For example, a bespoke table may incorporate steel construction of extremely high torsional stability of mainly hot-formed steel profiles with a plate thickness up to several millimetres. The framework can be open towards the bottom which allows working with tall pieces of art.

For purposes of description some references will be made to a painting as an illustrative example of an artwork, it being understood that the term “artwork” is not limited to paintings. The painting rests on the tabletop 104 with the underside surface (i.e. the back of the painting) facing the top surface of the tabletop 104. Two tracks 106 run along the tabletop 104 at the edges of the two relatively long sides 105 parallel to one another.

In the illustrated embodiment, a gantry 102 is mounted on the tabletop 104 and is configured to traverse along the two tracks 106. More specifically, the gantry 102 comprises a frame having a top member 111 with two opposing ends, the top member 111 being parallel to the tabletop 104, two uprights 114 extending downwardly (i.e. towards the tabletop 104) from opposite ends of the top member 111 and four gantry brackets 115. Each of the two uprights 114 is supported by two of the gantry brackets 115. The gantry 102 may be adjustable to enable clearance under the gantry that can be selectable, for example between 150 mm, 300 mm or 400 mm. In one embodiment, the table may be designed to support a load of 100 kg such that in the middle of the Y axis the gantry 102 of the table flexes only 0.02 mm to support artwork up to approximately 70 kg without loss of accuracy.

Referring to one of the uprights 114, each of its two supporting gantry brackets 115 have opposed ends with the first end attached near the end of the upright 114 proximal to the top member 111 and with the second end attached to a track follower (not shown) so as to form a triangle with the upright 114 and track follower. The track followers each engage with the tracks 106 so that the gantry can traverse the tracks 106 and thereby traverse the tabletop 104.

The gantry uprights 114 may be composed of monoblock aluminum or another suitable material. The top member 111 is stiffened in the vertical direction (i.e. perpendicular to the tabletop 104) so as to minimize sagging. The top member 111 causes the two uprights 114 to move in unison.

The tabletop 104 may be of a rectangular dimension sized to approximate different artwork sizes. It is recognized that larger tabletops 104 may require the gantry to be of a more robust construction.

Four adjustable fences 110 are adjustably attached to the tabletop 104. One fence 110 is attached near each table edge and generally parallel to each respective table edge. The two fences 110 that are attached near the relatively long sides 105 are attached interiorly of the tabletop 104 relative to the tracks 106. Each fence 110 is shorter than the length the respective tabletop 104 edge, and is preferably of adjustable length (e.g. telescopic) so that the fences 110 are adjustable to form rectangles of various dimensions in order to centre the artwork on the tabletop 104. According to an embodiment, each fence 110 is constructed of aluminum.

The fences 110 may be pneumatically or electromechanically controlled. A pressure switch 112 (or a plurality of pressure switches 112) may be mounted on the contact surface of each fence 110.

The adjustable fences 110 work in opposition, centering the artwork in the (X,Y) direction relative to the surface of the tabletop 104. The fences 110 may be on tracks or bearings or other suitable adjustable attachment mechanisms in order to allow the fences 110 to move around the tabletop 104. The fences 110 are configured to abut the artwork so as to secure the artwork on the tabletop 104. The fences 110 may be replaceable and interchangeable to accommodate different sizes of paintings or other types of artworks. For example, alternate fences may provide downward rather then inward pressure to hold a comic book on the surface of the tabletop 104. The pressure switch 112 (or pressure switches 112) on a chosen fence 110 measures the pressure of that fence 110 on the edge of the painting.

The artwork authentication system 100 further comprises a computer 116 having a processor, memory and at least one storage device (e.g. hard drive, flash drive, etc.). The computer 116 will also have a user interface, which may be specialized for the artwork authentication process. The computer 116 may be integral with the tabletop 104 or may be a separate device. The processor executes instructions stored on the storage device. Instructions may be entered into the user interface for storage onto the storage device and/or execution by the processor. The storage device may be integral with the computer or may be a removable storage device, such as a flash drive for example.

The computer 116 may be coupled to actuators for each of the fences 110 in order to operate the movement of the fences 110 through the processor's execution of instructions on the storage device. The computer 116 thereby adjusts the fences 110 to control the pressure of the fences 110 on the painting to ensure the fences 110 apply sufficient pressure to hold the paining firmly without damaging the artwork in any way. The clamping pressure of the fences 110 on the artwork may be automatically adjusted by the processor's execution of instructions stored on the storage device or may be manually adjusted. A facility may be provided to manually adjust the fences 110.

The system, when used for authenticating paintings, may be suitable for use either with paintings in their frames or not. Moreover, it may be adapted to other types of artwork.

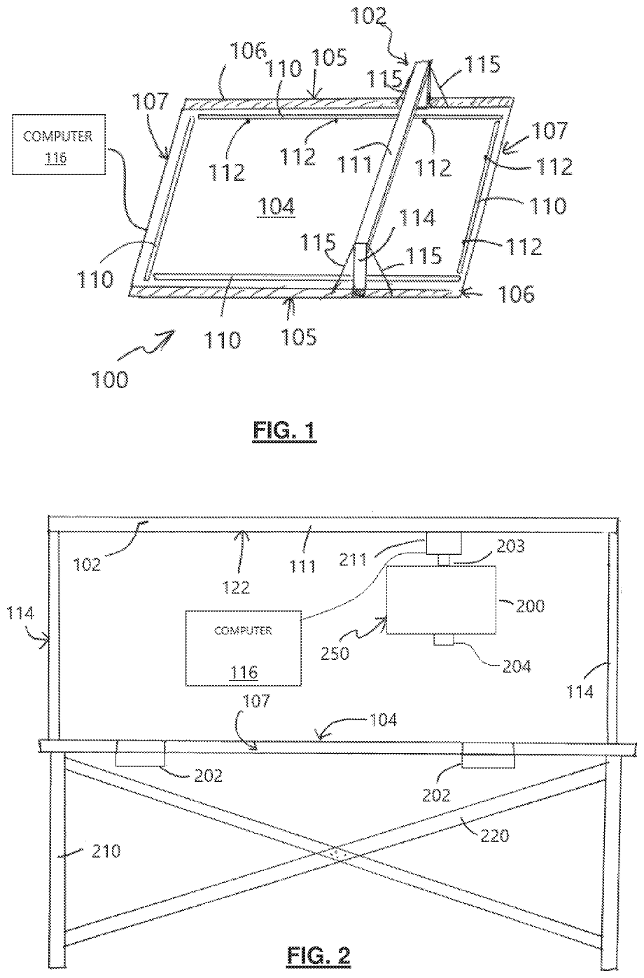

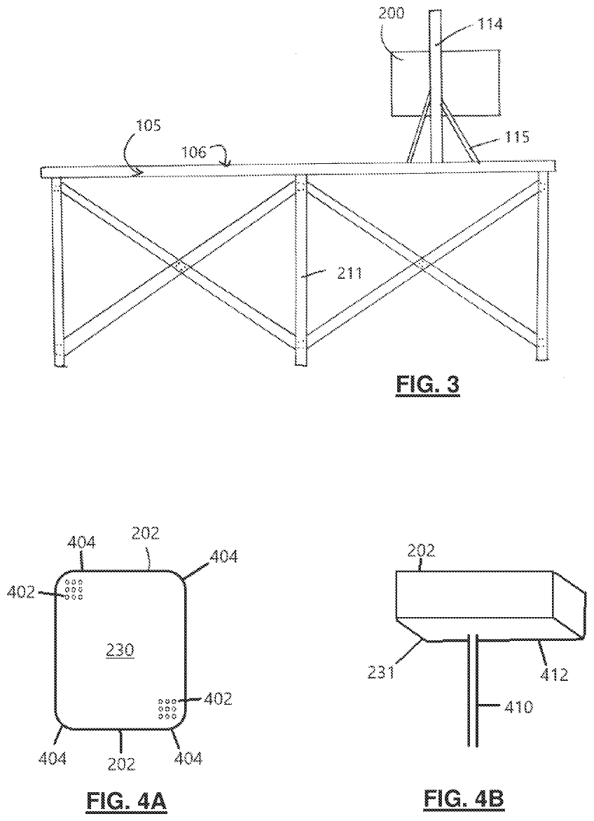

Referring to FIG. 2, which shows a side plan view of the relatively short side 107 of the tabletop 104, the tabletop 104 has four legs 210 (only two are shown) with one at each corner. The sides of the tabletop 104 are supported by cross-beams 220 attaching adjacent legs 210 (only on set of cross-beams is shown). Alternatively, referring to FIG. 3, there may be a third leg extending underneath each of the relatively long sides 105 of the tabletop 104 from the approximate centre of the tabletop 104. In the case in which three legs extend from the side of the tabletop 104, there may be two sets of cross-beams 220 each attaching the third leg 211 to an adjacent corner leg 210.

The top beam 111 comprises a bearing surface 122 along the length of its underside. The bearing surface 122 serves as a mounting point for a three-dimensional imaging assembly. In the preferred embodiment shown, the three-dimensional imaging assembly is an interferometer assembly 250. The bearing surface 122 enables the interferometer assembly 250 to traverse the length of the top beam 111.

Still referring to FIG. 2, the interferometer assembly 250 comprises a controller 211, an interferometer 200 and a camera having a lens 204. One side of the interferometer 200 is attached by a longitudinally adjustable element 203 to the controller 211. The opposite side of the interferometer 200 is attached to the camera, with the lens 204 of the camera facing away from the interferometer 200. The side of the controller 211 opposite the longitudinally adjustable element 203 is attached to a track (not shown) which slideably engages with the bearing surface 122 so as to provide a mechanism to position the camera of the interferometer assembly 250 accurately in one direction (i.e. the direction of the top beam 111). This is merely one illustrative mounting configuration and is not intended to be limiting.

The interferometer assembly 250 is used to take image scans. The interferometer assembly 250 uses laser beams or white light to yield 3-dimensional topographic maps or surface profiles of the artwork secured on the tabletop 104. The interferometer 200 resolves precise details of the artwork. The scan resolution is preferably 2 microns or better laterally, and preferably 200 nanometers vertically, more preferably 100 nanometers or better (for reference, a human hair is between 50-200 microns thick). In some embodiments, the interferometer is a suitably adapted model H8 interferometer offered by Heliotis AG, having an address at Langenbold 5, CH-6037 Root (Luzern), Switzerland. Other suitable interferometers may also be used.

The computer 116 is coupled to the actuator(s) for the adjustable element 203 so as to control the longitudinal movement (i.e. perpendicular to the tabletop 104 and hence artwork surface) of the camera lens 204. While in the illustrated embodiment the intereferometer has been depicted as a single unit, in other embodiments various components of the interferometer may be separated so that, for example, only the camera is moved relative to the artwork while the interferometer itself is elsewhere.

FIGS. 4A and 4B show, respectively, a top plan view and a side perspective view of an elevator 202. There may be a plurality of elevators 202 on (or collectively forming) the tabletop 104. Each elevator 202 has a number of apertures 402 extending therethrough to allow air to flow through the elevator 202. The top surface 230 of the elevator 202 is planar and the corners 404 of the elevator are rounded so as to not damage the artwork during operation.

The top surface 230 of each elevator 202 is fitted with at least one pressure switch and preferably a plurality of pressure switches. The pressure switches measure the pressure of the elevator surface 230 on the underside of the artwork. The pressure switches may be configured to automatically cease the movement of the elevator 202 after a certain pressure is reached so as to inhibit damage to the artwork. The pressure switches are adjustable and capable of having several set points, with each set point being a pressure level above which the movement of the elevator 202 ceases. Alternatively, once the pressure on the underside of the artwork is reached, the pressure switches may cause the elevator 202 to lower from the underside surface of the artwork. In an alternative embodiment the proximity sensors are used instead of pressure sensors to limit the upward travel (i.e. towards the artwork held on the tabletop 104) of the elevators 202. In a further alternative embodiment, micro switches are used instead of pressure sensors to limit the upward travel (i.e. towards the artwork held on the tabletop 104) of the elevators 202.

The underside of each elevator 202 is attached to an adjustment mechanism which can adjust the elevator in a vertical direction (i.e. perpendicular to the tabletop 104 and hence the artwork surface). When each elevator 202 is adjusted the surface 230 of the elevator 202 remains parallel to the surface of the tabletop 104. Each elevator 202 can rise from the table surface under pneumatic or electromechanical control. For example, the computer 116 (or alternatively a separate computer) may be coupled to the adjustment mechanisms for each elevator 202 so as to control the adjustment of each elevator 202. It is recognized that each elevator 202 may alternatively be pneumatically or alternatively manually operated using suitable mechanisms known to a person of ordinary skill in the art. The elevators 202 may vary in size depending on the overall size of the tabletop 104 and may have rounded-over edges to minimize the possibility of damaging the artwork. The perimeter or, alternatively, the entire surface of the elevator 202, may be magnetic so that in the event the artwork is on some non-flexible material, a collar of magnetic or electromagnetic material can be affixed to the artwork to ensure complete contact with the elevator 202.

In one embodiment, a vacuum system (not shown) with an adjustable vacuum is fitted to a manifold below the tabletop 104. One end of a tube 410 (FIG. 4B) attaches to the vacuum mouth with the opposite end of the tube 410 is fitted to a manifold 412 that is in fluid communication with the underside 231 of the elevator 202; in some embodiments there is a single manifold 412 and in other embodiments each elevator 202 may have its own manifold. This ensures that the vacuum, when in operation, distributes its pressure or sucks air evenly through the apertures 402 of the elevator 230. Preferably the connection formed between the vacuum system, tube 410, manifold 412 and elevator 202 is sealed.

Environmental factors (e.g. humidity) can affect the canvas position enough to distort the relative vertical or z-position (i.e. in the axis perpendicular to the tabletop 104 or artwork secured thereon). The function of the vacuum system is to pull the canvas (e.g. for a painting), or other material, taught over the surface of the tabletop 104, so that only the surface of the artwork and not undulations therein will be scanned. The degree of vacuum pulled may be adjustable. Using the vacuum system opposite the interferometer 200 flattens the canvas and results in consistent relative z-coordinates. This approach is of course unsuitable for fragile artworks, and other accommodation for environmental factors are described below. In addition, or alternatively, even if the amount of horizontal (e.g. along the plane of the artwork surface) stretch was different between scans of two artworks being compared, the system could compensate for this difference using software methods to apply a horizontal stretch or compression as will be understood by those skilled in the art, now informed by the present disclosure.

An articulated robotic arm (not shown) may be used as an alternative to the gantry 102. The robotic arm may be mounted on the side or at one corner of the tabletop 104, for example, with the distal end of the robotic arm holding the interferometer assembly 250 or, alternatively, only the camera 204 of the interferometer; in such an embodiment wires could run from the camera 204, along the articulations of the robotic arm, to the interferometer 200 itself, which could be mounted in a cabinet underneath the table, or communication could be wireless. The computer 116 may be coupled to the actuators of robotic arm in order to automatically control the movement of the robotic arm and hence the position of the camera lens 204 in relation to the tabletop 104. The robotic arm would have sufficient degrees of freedom and movement that it is able to position the camera 204 at any location on the tabletop 104, to accommodate the maximum size of artwork. In a further alternative embodiment, a smaller robotic arm may be mounted on a track running along one of the long lengths of the tabletop 104, and only needs to reach the full width of the table to address any part of the artwork.

In alternative embodiments, a suitable interferometer may be mounted on one or more suitable remotely piloted, autonomous or semi-autonomous vehicles, including flying vehicles (e.g. multi-rotor aircraft such as quadcopters, hexcopters, octocopters, etc.), either purpose-built or adapted from commercially available models, or ground-based vehicles (e.g. a tracked or wheeled vehicle or robotic quadruped), all of which are collectively referred to herein as “drones”. The drone can, either autonomously, semi-autonomously, or under operator control, move to the artwork and position itself in registration with the relevant portions of the artwork, for example using manually or automatically pre-set registration coordinates for the particular artwork, in conjunction with an onboard 2D image camera. At this point, the drone can use its interferometer to capture the three-dimensional topographical image information, which can be stored onboard for later download or be wirelessly transmitted (e.g. Bluetooth) to a receiver for further processing. GPS, Wi-Fi or cellular triangulation may be used for navigation to particular artworks within a facility.

The drone embodiment has particular application in art galleries, museums and other similar facilities as part of a routinized security protocol. Drones, both airborne and land based, have already been proposed for use in security patrols. Such security drones could incorporate or be equipped with an interferometer and laser/LIDAR/acoustic or other positioning systems and, as part of their patrol protocols, capture three-dimensional topographical image information for artworks on display, which could then be compared to the reference information (either on board the drone, or remotely following wireless transmission). This would allow real-time verification (e.g. weekly or nightly) of the authenticity of the displayed artworks, to guard against a scenario in which miscreants stole a valuable artwork and replaced it with a forgery to conceal their perfidy. Such a switch, which might otherwise go undiscovered for years, could be immediately identified by a security drone implementing aspects of the present disclosure. A similar approach could be implemented by human security guards using a portable system according to the present disclosure, as discussed further below.

The artwork authentication system 100 may be in several different sizes or dimensions to accommodate different artwork dimensions. The camera 204 of the interferometer 200 is mounted either on the gantry 102 or a multi-axis robotic arm as preferred, or on a drone, or as otherwise dictated by the circumstances. For example, stabilized mobile camera systems used in the motion picture industry may also be adapted for use in implementing aspects of the present disclosure. A wide range of systems may be used to mount, deploy and position an interferometer or other three-dimensional imaging system to effectuate aspects of the present invention by obtaining three-dimensional topographical image information for artworks.

An artwork authentication system 100 as shown in the figures may, for example, be located in specific art-centric cities to which priceless works can be brought either by an insurance company, museum, or private individual (in the case of private ownership) in order to be placed in the artwork authentication system 100 for imaging and cataloguing.

However, the facility in which the art pieces are displayed will have some measures for environmental control, as they normally would to protect the art pieces. This, coupled with the fact that such priceless works of art are quite old, sometimes hundreds of years, and are mounted within some type of rigid frame, may mean that the work of art has settled into some form of stable matrix. The work may also be so valuable that moving it creates a heightened risk of theft. Thus, in some instances, it may be dangerous, expensive or impractical to move the artwork.

In an alternative embodiment, an artwork authentication system according to the present disclosure will be portable. In this manner, where it is impractical or infeasible to transport specific works of art from say, a museum, to a remote location where a non-portable artwork authentication system 100 resides, the portable artwork authentication system can be brought directly to the work of art. Three-dimensional topographical image can be captured by the portable artwork authentication system. More specifically, the art piece can remain hanging in place on the wall or in its decorative position, in most circumstances, and will not need to be removed, transported, or tampered with in any way. The Mona Lisa, for example, can remain where it is on display at the Louvre and the portable artwork authentication system will perform the necessary work on site.

Elements of the portable artwork authentication system may include mechanisms, such as a specialized lifting mechanism, being married to a number of compact shapes which are practical for mobility. In the former case, these mechanisms can utilize mechanical devices such as rack and pinion, screw threads, or a scissor lift. A smaller unit might not have a motive drive and will, therefore, require some external force, such as being powered by the operator, in order to extend or retract. In the latter case, a special custom case such as a Pelican™ case, may be used to facilitate transport. The units may also be equipped with suitable outriggers below and/or above, for security and minimization of vibration, in the case of the top which will house the interferometer assembly (or the camera of the interferometer). Such a unit will be able to fit within a standard doorway and can be self-propelled and/or be suitable for transport on the back of a truck, or in an SUV or other suitable vehicle on city streets. The portable artwork authentication system would be moved in front of the artwork, and lasers/LIDAR/acoustics or other sensors may be used to establish a proper distance and planar orientation with the artwork.

The environment in which artwork is stored or displayed has a significant impact on its condition and long-term preservation. These factors can include such things as relative humidity (RH), temperature and barometric pressure, as well as pollution and biological activity.

The safest RH for paintings on canvas or wood is a stable level between 40% and 60%. National and international consensus has favoured a central value of 50% RH for the sake of uniformity between lending institutions.

During winter, interior heating without humidification will result in very low RH levels. For the sake of simplicity, consider a case where an artwork is a painting. The painting's ground and paint layers contract to differing degrees in response to these conditions and become increasingly brittle. This introduces strains into the painting. These strains are exacerbated by actions, such as keying out, erroneously taken to correct slackness in the canvas that occurs at low RH levels. Keying out, which places the canvas under more tension, can result in the development of cracks in the brittle ground and paint layers. Cracking can then lead to lifting paint and paint loss. For paintings on canvas, handling during low RH conditions can also place the painting at greater risk of damage to brittle ground and paint layers.

As humidity levels fall, exposed, unpainted wood on the verso of panel paintings loses moisture more rapidly than the painted recto surface. The wood on the back of the panel contracts from this moisture loss and a warp develops. Dimensional changes to wood from contracting at low RH conditions are much greater than those of the paint and ground layers. When the wood under these layers begins to shrink, paint and ground break away from the wood and are forced up, forming ridges or “tents.” In extreme dry conditions, seams in composite wood panels can crack or open up.

In summer, the RH in indoor environments is often high. At RH levels above 75%, some canvases will shrink at the same time that the wooden stretcher or strainer is expanding. This increases strain in the paint and ground layers. Often deformations in the canvas are naturally resolved during periods of higher humidity. For instance, corner draws caused by greater contraction at the centre of the canvas during periods of low humidity are pulled flat. If the stretcher has been keyed out to deal with such deformations prior to an increase in humidity levels, the additional contraction of the canvas at the higher RH can cause cracking to paint and ground layers. In the case of paintings on wood panels, the wood expands (across the grain) to a greater extent than either paint or ground layers in response to an increase in ambient RH. A distinctive, fine crack pattern is often noted on these works of art with cracks running perpendicular to the wood grain.

RH levels over 70-75% will encourage mould growth. These high RH levels can occur in areas of an exhibition or storage space that are cooler than the rest of the room (e.g. against exterior walls, near water pipes) despite good conditions in the centre of the rooms.

High temperatures (over 30° C.) combined with high humidity can soften paint and varnish layers, allowing dirt to stick more easily to these surfaces. Exposure to high temperatures as a result of direct sunlight or high-intensity lamps placed too close to the surface of a painting can cause localised desiccation of paint, ground, size and canvas or, in a worst-case-scenario, blistering of paint and varnish.

Low temperatures cause ground and paint layers to become more brittle and susceptible to damage when the painting is moved or subjected to shock. Acrylic paintings are particularly susceptible to cracking under cold conditions because their glass transition temperature (the temperature at which a polymer changes from rubbery and flexible to glassy and brittle) is in the range of 5-10° C., considerably higher than that of oil-based paint (−5° C. or lower).

If paintings are stored, transported and displayed at temperatures within the human comfort zone, they are typically at low risk from temperature-related problems. The recommended set point, according to American Society of Heating, Refrigerating and Air-Conditioning Engineers (ASHRAE) and Canadian Conservation Institute (CCI) guidelines is anywhere in the range of 16-25° C.

It is sufficient for most purposes here to know that when warm air is cooled, the RH climbs. This leads to problems of damp when warm humid air finds cool spots in a building. The converse is that when cold air is heated, the RH falls. This leads to low indoor RH in winter, and drives the need for humidifiers. The target value of temperature or RH that a mechanical system is designed to maintain over time is known as the “set point”. However, even the best mechanical systems will produce values that fluctuate above and below the given set point.

As a consequence of such environmental factors, three-dimensional topographical image information of artwork at the micron or nanometer level will change based on the condition of the artwork at the time that a three-dimensional topographical image is captured. These variations may affect the algorithmic accuracy of systems and software based on machine learning, AI, or metrology to determine whether two three-dimensional topographical images of the same portion of an artwork from scans carried out at different points of time and, possibly, in two different global locations (such as when a piece of artwork is lent from a museum in one country to a museum in another, or in circumstances when artwork is part of a world tour programme) are the same or whether they are different. This is critical to determining the authenticity of the artwork, i.e. it is the same piece of art or has a forgery been substituted between a prior scan and the current scan.

As such, particularly preferred embodiments of art authentication systems and methods take account of environmental condition information at the time the three-dimensional topographical image information is captured. Environmental condition information can be used to address microscopic variations addressed in several ways. This can include using mathematical variances applied to the three-dimensional topographical image information in order to “standardize” it within a common three-dimensional environment that accounts at least for variances in RH, preferably at least for variances in both RH and temperature and more preferably for variances in RH, temperature and barometric pressure. Suitable mathematical transformations may be determined, for example, by experimentation or other suitable methods which are within the capability of one of ordinary skill in the art, now informed by the present disclosure. Another method might include carrying out all capture of three-dimensional topographical image information for artwork inside a special “clean room” that has a constant RH and temperature (and also preferably a constant barometric pressure) within which the artwork is first acclimatised for a standard period of time (e.g. 24 hours) before the three-dimensional topographical image information is captured. Each facility where the three-dimensional topographical image information is captured may have its own such clean room.

The Methodology

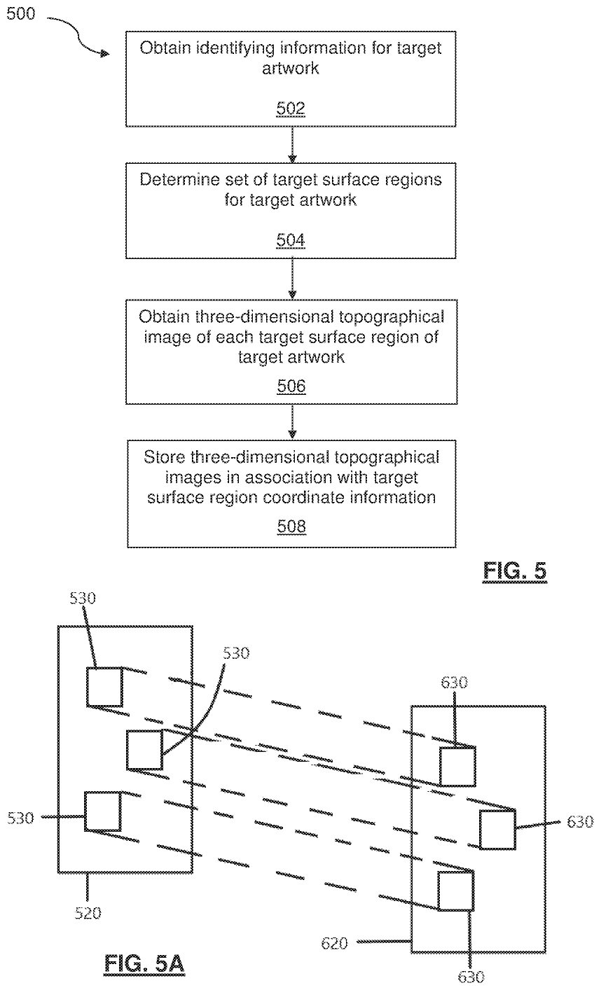

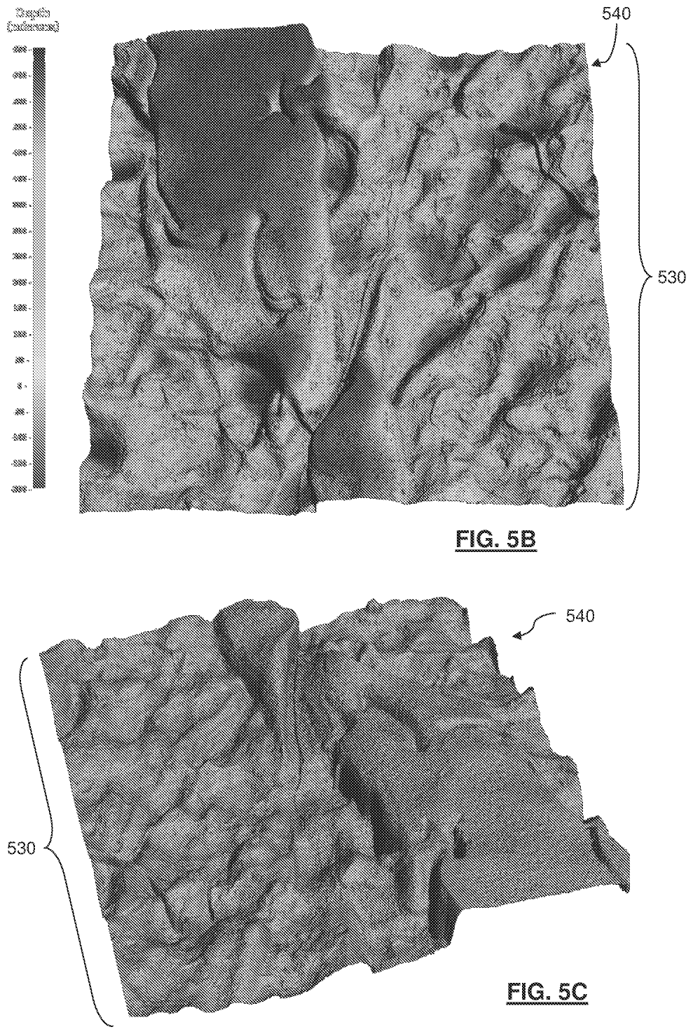

Referring to FIG. 5, the artwork authentication system 100 works by first obtaining identifying information for the target artwork, including at least a target artwork identifier and dimensions of the target artwork, at step 502. This information can be entered manually by an operator, or obtained digitally, for example from an RFID or similar device. The identifying information may include demographic information, for example, the name/title (or other identifier), date of production/release, artist(s), frame (absence or presence, width), owner, status (e.g. on loan from another institution), etc. Preferably, the identifying information is a set of information sufficient to uniquely identify an artwork. This may be trivial in the case of a unique work, but may require additional information where are artwork is not unique (for example, copies of issue #1 of Action Comics (the first appearance of the Superman character) are extremely rare and valuable, but not unique. In a preferred embodiment, a target artwork identifier may be used, which may be a unique letter, numeric or alphanumeric code associated with corresponding information stored in a database. A two-dimensional digital photograph of the artwork may also be added to the file. For example, a digital camera using conventional DSLR photographic techniques may take an image of the entire artwork 520 clamped in the tabletop 104 in order to store the entire image in the storage device.

After the artwork has been secured and centered on the table, or otherwise positioned relative to the system for an initial scan, an operator may enter two numbers into the system when prompted. These values will correspond to the number of three-dimensional topographical images to be obtained, and the size of each three-dimensional topographical image. An alternate embodiment would predetermine the number of three-dimensional topographical images based on the size of the artwork, with the operator potentially able to override the predetermined number. It is expected that with experience, a standard size of three-dimensional topographical image will be determined. As a general rule, the largest area that is practical will be scanned. In any case, the values selected will be stored as part of the demographic information for the artwork.

At step 504, the computer then determines a set of target surface regions, each target surface region being a portion of an overall surface of the target artwork. The computer then determines coordinate information identifying and locating each target surface region relative to the overall surface. In one embodiment, the target surface regions are randomly generated. In FIG. 5A, an illustrative target artwork is shown schematically at 520, and the locations of the target surface regions of the target artwork 520 are shown schematically at 530. Alternatively at step 504, instead of generating a random set of target surface regions 530, the computer may use a specific formula to determine the target surface regions 530 based on a set of criteria, such as the size of the artwork. If the presence of a frame has been indicated, then the range of possible (X, Y) values available for selection may be truncated by the frame width plus a predetermined safety factor to avoid the interferometer or camera coming into contact with the frame. In one embodiment, a virtual grid is defined over the artwork and an algorithm then determines specific “cells” (i.e. the target surface regions 530) of the grid that are to be scanned. These cells may be square or have other shapes. For example, on one piece of artwork three areas will be scanned, for another only one, and yet another five; thus, a “set” of surface regions includes a set consisting of a target single surface region. The locations of the surface regions may be stored and a visual representation of dots or other registration marks may be overlaid on the digital image of the artwork; the position of the registration marks will correspond to the determined target surface regions on the actual artwork. This can be displayed to an operator, and as each surface region is scanned its representative marking can change colour. In addition, a progress bar can be displayed, indicating the time remaining to complete all scans.

At step 506 the artwork authentication system 100 is used to obtain a three-dimensional topographical image of each target surface region 530 of the target artwork. At this step 506, the artwork authentication system 100 takes a series of interferometer scans over the target surface regions 530 of a target artwork 520. These scans produce topographic maps of each target surface region 530. These are highly precise, detailed three-dimensional digital representations of the surface regions 530 scanned. The scan resolution is preferably 2 microns or better laterally, and preferably 200 nanometers vertically, more preferably 100 nanometers or better. FIGS. 5B and 5C show, respectively, a top plan view and top perspective view of an illustrative three-dimensional topographical image 540 of a target surface region 530 of an illustrative sample painting, taken using an interferometer.

In one embodiment, as each scan of a particular target surface region 530 is completed, the corresponding three-dimensional topographical image is rendered and displayed as a depth sensitive colored image with user selectable scaling (and other rendering as may be desired). As soon as one target surface region 530 has finished scanning, the interferometer camera may be moved to the next target surface region 530 to begin scanning. While this next scan is ongoing, a user can review the rendering from the scan of the previous target surface region 530 and either accept it or indicate a rescan. If accepted, the corresponding three-dimensional topographical image is saved; if a rescan is selected then a rescan order will be placed at the end of the scan list and that surface region 530 will be rescanned a later time. Preferably, the artwork authentication system 100 is configured so that once the target surface regions 530 have been identified, the system will continue autonomously until all the target surface region 530 are scanned. Thus, an operator can leave the artwork authentication system 100 to scan on its own, and when the operator returns, the corresponding three-dimensional topographical images will be presented sequentially and either accepted or rejected and rescanned as required. During the autonomous scans, the artwork authentication system 100 may be locked, for example by password or biometric information.

Once all the scans have been completed, the data is confirmed and saved to a unique file and catalogued in a database. The interferometer camera returns to its rest/ready position and the next artwork can be scanned.

In the embodiment using a robotic arm, when the interferometer camera has completed taking image scans, the interferometer camera moves away from the artwork (being controlled by the computer), the head of the camera retracts, and the robotic arm moves away. In an embodiment incorporating a drone, after all scans for a particular artwork are complete, the drone may return back to its base unit where it can charge or, if instructed to, will move on to the next piece of artwork that is in its process queue.

At step 508, the three-dimensional topographical images are then stored on the storage device of the computer 116 in association with coordinate (location) information for the target surface regions. In particular, the computer 116 stores the identifying information, the coordinate information and the topographical images or maps so that the coordinate information and the topographical images or maps are associated with the artwork identifier and each topographical image or map is associated with its corresponding coordinate information. The three-dimensional topographical images, together with identification of the corresponding target surface regions from which they are obtained, serve as a form of “fingerprint” for the artwork, specifically a three-dimensional structural “fingerprint”. Information about the artwork (e.g. specific provenance information, current owner, etc. along with position (coordinates) of the scans can be encoded within QR codes and also encrypted onto an RFID chip embedded within an “identity card” that can be produced for the artwork. This is similar to a driver's license, biometric identifier or “passport” for an individual, but will be specific to the artwork, with embedded information that can be “inquired” for verification or comparison purposes. Such information could also be encoded into a storage device coupled to a transponder having a suitable power source that is long lived and/or capable of being wirelessly charged while in stasis (e.g. hanging in a gallery or museum), so that its location can also be tracked dynamically or when needed, such as when in transit, e.g. when moved if the artwork is being lent from one museum to another. Such information may also be encoded in a blockchain application for facilitating temporary or permanent transfers of artwork by providing additional verification of changes in physical custody and/or legal title.

While FIG. 5 shows all three-dimensional topographical images being obtained at step 506 and then stored at step 508, this is for simplicity of illustration; typically each three-dimensional topographical image will be stored before the next three-dimensional topographical image is obtained.

As noted above, particularly preferred embodiments take account of environmental condition information at the time the three-dimensional topographical image information is captured. Preferably, the environmental condition information includes at least relative humidity (RH), more preferably at least RH and temperature, and most preferably at least RH, temperature and barometric pressure. It is contemplated that an embodiment may account for only RH as environmental condition information, only temperature as environmental condition information or only barometric pressure as environmental condition information, or only RH and temperature as environmental condition information, only RH and barometric pressure as environmental condition information, or only temperature and barometric pressure as environmental condition information.

Where environmental condition information is accounted for, in one embodiment step 508 may further comprise storing environmental condition information for the three-dimensional topographical image of each surface region. In another such embodiment, the method 500 may comprise, before storing the identifying information, the coordinate information and the topographical images at step 508, obtaining environmental condition information for the three-dimensional topographical image of each surface region and using the environmental condition information to standardize the three-dimensional topographical image of each surface region. Thus, in such an embodiment the topographical maps that are stored may be standardized topographical maps. In some embodiments, unique environmental condition information may be captured for each individual three-dimensional topographical image of each target surface region 530; in other embodiments common environmental condition information may be used for all three-dimensional topographical images of the target surface regions 530. In other embodiments, obtaining the three-dimensional topographical image of each surface region at step 506 is done in standardized environmental conditions (e.g. a “clean room”).

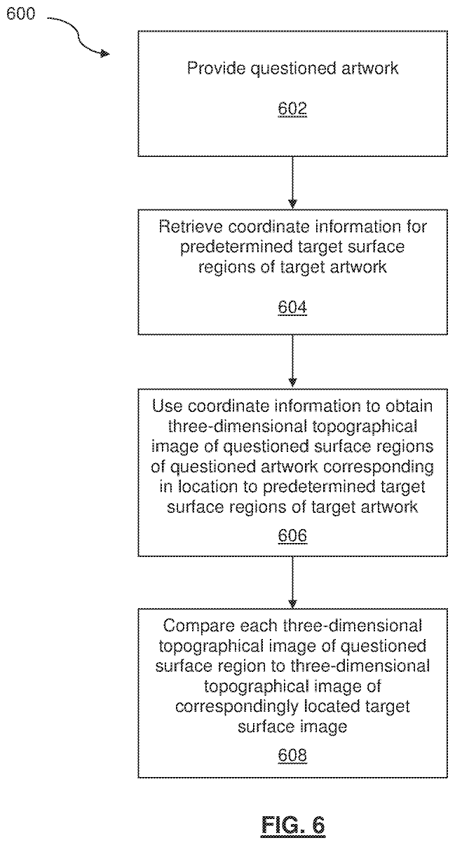

Referring to FIG. 6, a method 600 to authenticate a questioned artwork using the artwork authentication system 100 is shown. It should be noted here that the authentication is of the questioned artwork in respect of a particular target artwork. Thus, there is a requirement of independent authentication before the target artwork is initially scanned in the method 500. This may be trivial when the target artwork is scanned immediately after production by the artist(s), or where the target artwork is unique and its provenance is unquestioned (e.g. the Mona Lisa secured in the Louvre). However, the limitation of requiring independent authentication before the target artwork is initially scanned is of particular import for cases where the target artwork is one which, while originally produced in some volume and intended to be identical, has become valuable over time and hence worthy of authentication. Consider the case of a rare baseball card originally in a private collection, and which was scanned as a target artwork according to the present disclosure. If the card were later stolen and then a card purporting to be the stolen card were to be recovered, the recovered card could be scanned as a questioned artwork and compared to the target artwork (the card from the collection). A match would confirm that the recovered card was the same one taken from the collection, but would not necessarily confirm that the card itself was genuine—absent independent authentication, the collector may have (perhaps unknowingly) had a counterfeit card all along. Thus, it should be noted that the present disclosure is, in one aspect, directed to determining whether a questioned artwork is a forgery of a particular individual target artwork, and not to whether a questioned work is a counterfeit of a general class of artwork. For example, in the case of paper currency, the present technology could determine whether a questioned banknote was the same as a particular authenticated previously scanned target banknote, but could not necessarily determine whether an arbitrary banknote was counterfeit. In this sense, the present disclosure uses the term “forgery” to refer to a reproduction falsely purporting to be a specific unique item (including a unique instance of a class of item), as distinguished from a “counterfeit”, which refers herein to a reproduction falsely purporting to merely be a genuine member of a class of item without necessarily purporting to be a particular unique member of that class. Accordingly, an “artwork” is a specific unique instance, and not a general class. Thus, the term “artwork” would include a unique, previously authenticated instance of a particular banknote owned as a collectable item, but would not include the general class of genuine banknotes for use as legal tender. Similarly, the term “artwork” would include the (likely expired) specific, previously authenticated passport or driver's license of a famous individual (e.g. Chuck Norris) owned as a piece of celebrity memorabilia, but would not include the general class of authentic, validly issued passports. Therefore, the present technology could be used to determine, for a particular unique document so purporting, “this is (or is not) the previously authenticated expired passport of Chuck Norris” but not to determine, for some arbitrary document purporting to be an arbitrary passport of an arbitrary person, “this is (or is not) an authentic, validly issued passport”.

After providing the questioned artwork at step 602, at step 604, the computer retrieves from the storage device coordinate information for the target artwork 520 identifying and locating each of a plurality of target surface regions 530 of an overall surface of the target artwork 520.

At step 606, the coordinate information is used by the artwork authentication system 100 to obtain a three-dimensional topographical image of a plurality of questioned surface regions 630 of an overall surface of the questioned artwork 620, each questioned surface region 630 corresponding in its location on the overall surface of the questioned artwork 620 to a location of a corresponding one of the target surface regions 530 of an overall surface of the target artwork 520.

The topographical maps can be compared in a number of ways including through the use of pseudo-colour which will ascribe predetermined colours to various depths of each topographical map resulting from each target surface region, by scaling various features of the artwork in the vertical axis (i.e. perpendicular to the tabletop 104 on which the artwork is clamped) using internal mathematical algorithms in order to accentuate specific details, or in wireframe or greyscale. Pseudo-colour may also be used to ascribe predetermined colours to various differences in depths between two topographical maps being compared to one another. For example, a green region on an overlay of two topographical maps might indicate that the depth in that region is similar, while a red region on the overlay would indicate that the depths in that region is dissimilar as between the two topographical maps, or that one area is above or below the other.

This visualization of the topographical map comparison is presented on a user interface as is known in the art. Any discrepancies between a scan performed on a questioned artwork at one time to the target artwork scanned at another (likely earlier) time may be accounted for using software tools known in the art (e.g. VTK or Visualization Toolkit) and the observations of an art expert. For example, although some variation may have taken place, an expert can provide an expert opinion on whether the questioned artwork is authentic, using the visualization of the comparison and related software tools, which may be known in the art, due to the existence of sufficient clues of a match.

Using the compare mode from VTK, or a compare mode from software based on VTK or from software independent of VTK, different scans of the same target surface region, which may have been obtained at different times, can be compared side by side in much the same way that a ballistics expert will compare fired bullets or expended cartridge cases using a capability known in the field as Virtual Comparison Microscopy (VCM). Using an overlay mode from VTK or other software, the operator of the system can place a transparent image of one area over the corresponding area obtained from a different scan. While in the overlay mode, the operator can activate the “find similar” function from VTK, or a similar function from other software, and the Z-values of all the 3D volume elements, called voxels, will be compared and a colour-coded representation of the results will be overlaid on the images. This will give the operator instant feedback on the quality of the match at any given point. By repeating this process for all the surface regions (e.g. 530, 630), the operator can make the determination as to whether the two series of scans were taken from the same artwork. Other software functions which may be useful may include “show differences”, “find differences”, etc.).

Although it is contemplated that comparison of questioned artwork image data to target artwork image data for a particular target artwork may be carried out by a human expert, it is considered preferable to use a computer-driven, automated comparison for consistency and objectivity. Thus, at step 608, the computer compares each three-dimensional topographical image of a questioned surface region to a three-dimensional topographical image of a correspondingly located target surface image on the target artwork. Further, an automated matching algorithm can provide the percentage of a match between a questioned artwork versus that of a target artwork kept within a database. The results of this comparison will indicate whether the questioned artwork is likely the same as the target artwork (a high percentage) match, or is likely a forgery of the target artwork (a low percentage match).

Because the storage device stores the target surface regions of the target artwork which have been scanned, the artwork authentication system 100 need only scan those same target surface regions of the questioned artwork in order to undertake the comparison algorithm and certify the authenticity (or non-authenticity) of the artwork. The indication of the location of the target surface regions of the target artwork stored on the storage device may be stored as a unique code which may be encrypted.

No matter which embodiment of the artwork authentication system is used, it is preferable that there is a mechanism to accurately determine the target artwork's position in space (X, Y) and from that position, select a number of foci, around which scans of a given size will be initiated; these scans will be the target surface regions of the artwork surface. In one embodiment, the location of the scans will be determined by a random number generator, taken from the total series of (X, Y) values contained within the artwork (excluding the frame, if any). These values will be saved along with the scans and will provide a further level of security (i.e. even if an unscrupulous party were to try and scan an artwork, or even a portion thereof, and was successful, the likelihood that he would be able to determine the scan foci is low). The positioning may be accomplished through a combination of lasers and position encoders. It is assumed for discussion purposes that the surface of the artwork is substantially planar within the Z range (i.e. the axis perpendicular to the surface of the artwork) of the interferometer.

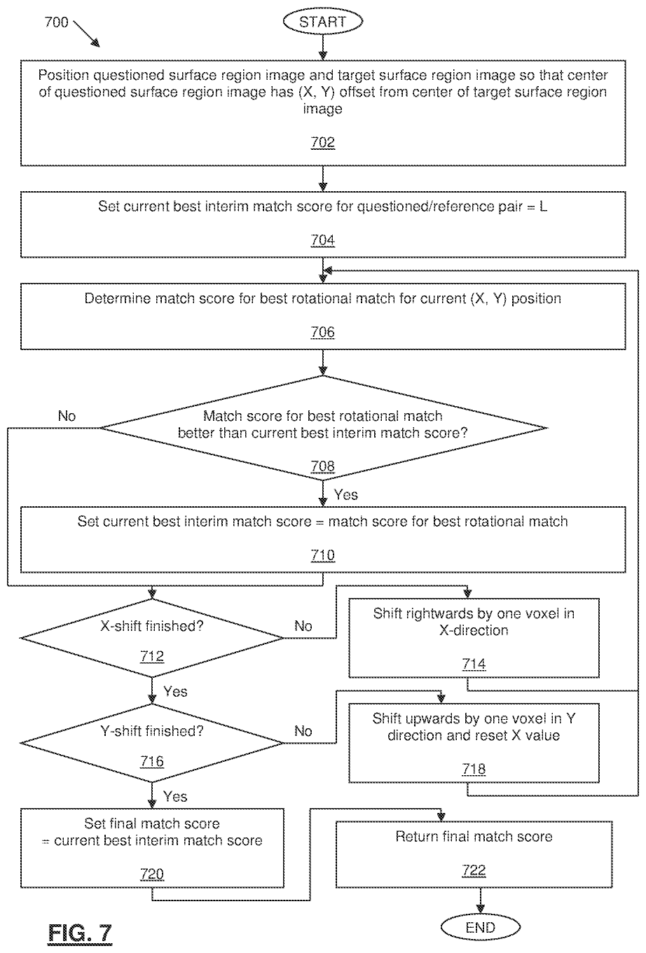

As noted above it is considered preferable to use a computer-driven, automated comparison of questioned artwork image data to target artwork image data for a particular target artwork. With reference now to FIG. 7, an illustrative method for automatically comparing questioned artwork image data to target artwork image data for a particular target artwork, and determining a final match score for that particular questioned artwork/target artwork pair, is shown generally at 700.

The method 700 is suitable for use with systems in which the questioned surface region images and the target surface region images are in three dimensions. In each artwork image, the elements of the three-dimensional image are referred to as “voxels”. A voxel is a three-dimensional analogue of a pixel. A “pixel” is defined as a “picture element”, meaning the minimum size of individual picture element that the system can generate, and a “voxel” is defined as a “volume element” comprising the minimum volume that a system can generate. A given voxel has an (X,Y) position in a plane corresponding to the plane of the face of the artwork, and a Z value representing the height above or depth below the plane at that particular point. Thus, all of the voxels taken together provide a topographical map of the surface region of the artwork.

It will be appreciated that in order for artworks to be properly compared to one another, they must be precisely aligned, and also that merely aligning the images of the questioned surface region and the target surface region of the respective artworks with one another may not be sufficient to ensure such alignment. This is because the position of a chosen point of the image of one region may not be exactly the same as the position of that same point in an image of a corresponding region (i.e. the relative locations of the points within the images may differ by some number of voxels in the X direction, Y direction, or both). The method 700 takes account of this by not only comparing the images when the center of the questioned surface region image is aligned with the center of the target surface region image, but also comparing the images when the center of the questioned surface region image is aligned with each voxel in a hypothetical predetermined grid surrounding the center of the target surface region image. Thus, the method 700 sequentially compares between the questioned surface region image and the target surface region image over a series of (X, Y) offsets between the images in addition to comparing when the images are exactly aligned. In effect, a hypothetical grid is overlaid on the region including the center of the target surface region image, the questioned surface region image is sequentially positioned with its center at each position on the gird, and a comparison is made at each point on the hypothetical grid.

Moreover, even if the chosen points of the surface regions are perfectly aligned as between images, they may have different rotational positions within the image such that (e.g.) the target surface regions and the questioned surface regions of the artworks do not occupy the same relative position. Accordingly, the method 700 takes account of the potential for both X and Y position shift within an image as well as differences in rotational position.

At step 702, the image of the questioned surface region is positioned relative to the image of the target surface region to which it is currently being compared so that the center of the image of the questioned surface region has an (X,Y) offset from the center of the image of the target surface region. That is, the center of the image of the questioned surface region is positioned to be offset by some number of voxels leftward in the X direction and some number of voxels downward in the Y direction from the center of the image of the target surface region. In the illustrative embodiment herein described, the effect is that the center of the questioned surface region image is aligned with the lower left corner of the hypothetical grid described above. It will be appreciated that step 702 may be executed in virtual space. The method then proceeds to step 704.

At step 704, the current best interim match score for the questioned artwork/target artwork is set to an arbitrary value “L”. The value “L” is an initialization value, and is set to represent a very poor match between the questioned artwork and the target artwork. The exact value will depend of the particular scale of the match score, which in the illustrative method 700 depends on the image resolution.

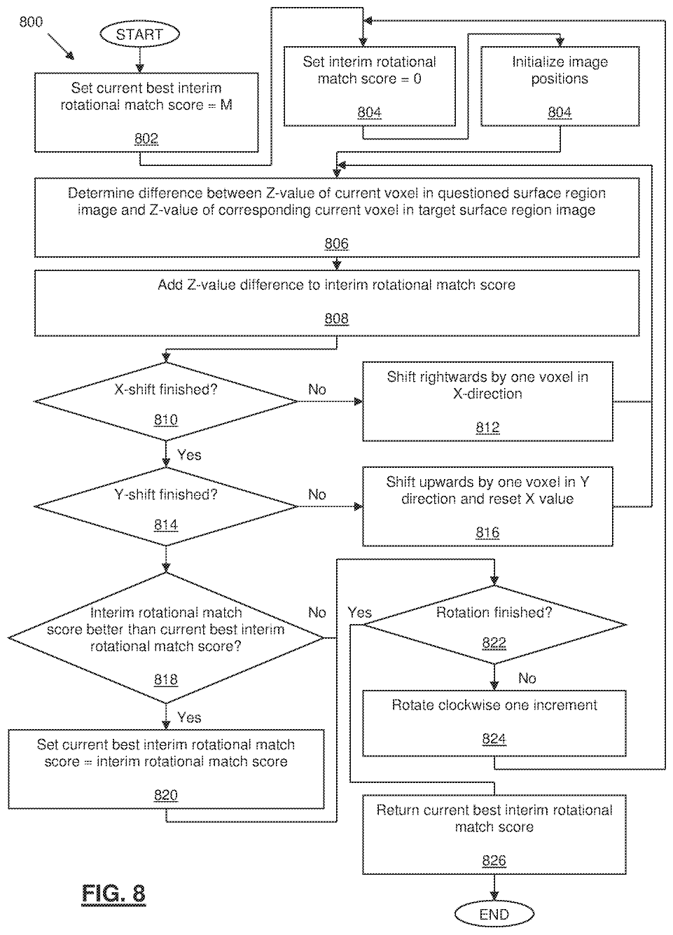

At step 706, the method 700 determines, for the current (X, Y) position, the match score for the best rotational match. A particular illustrative method 800 for determining the match score for the best rotational match at a given (X, Y) position is described in greater detail below in respect of FIG. 8.

At step 708, the method 700 checks whether the match score for the best rotational match at the current (X, Y) position is better than the current best interim match score. The nature of the test will depend on how the match score is calculated. Responsive to a “yes” determination at step 708, at step 710 the current best interim match score is set equal to the match score for the best rotational match (i.e. the current best interim match score is replaced by the match score for the best rotational match at the current (X,Y) position). The method 700 then proceeds to step 712. Responsive to a “no” determination at step 708, the method proceeds directly to step 712 (i.e. step 710 is omitted and the current best interim match score is unchanged).

At step 712, the method 700 checks whether the X-shift has finished, that is, whether alignment of the questioned surface region image relative to the target surface region image has advanced rightward in the X-direction by a predetermined number of voxels (i.e. one row in the above-described hypothetical grid has been traversed). Responsive to a “no” determination at step 712, at step 714 the alignment of the questioned surface region image relative to the target surface region image is advanced rightward in the X-direction by one voxel and the method 700 returns to step 706, so that the comparison will be repeated, only this time with the alignment of the questioned surface region image shifted one voxel to the right in the X-direction, relative to the target surface region image. Responsive to a “yes” determination at step 712, the method 700 advances to step 716.

At step 716, the method 700 checks whether the Y-shift has finished, that is, whether alignment of the questioned surface region image relative to the target surface region image has advanced upward in the Y-direction by a predetermined number of voxels (i.e. all rows in the above-described hypothetical grid have been traversed). Responsive to a “no” determination at step 716, at step 718 the alignment of the questioned surface region image relative to the target surface region image is advanced upward in the Y-direction by one voxel and the X value is reset. Thus, the alignment of the questioned surface region image will be shifted upward in the Y-direction by one voxel and shifted leftward in the X-direction by a preset number of voxels so that the center of the questioned surface region image is now aligned at the beginning (i.e. rightmost position) of the next row in the hypothetical grid. The method 700 then returns to step 706 to repeat the comparison for the first position in this next row.

A “yes” determination at step 716 indicates that the entire hypothetical grid has been traversed, so the method 700 proceeds to step 720, at which the final match score for the particular target artwork is set equal to the current best interim match score, and then proceeds to step 722, at which the method 700 returns the final match score.

Thus, the method 700 finds, for each alignment point in the hypothetical grid, the match score for the best rotational match and checks whether it is better than the current best interim match score, and if so updates the current interim match score accordingly. In virtually all cases, this match score will eventually become the final match score, since it will virtually always be better than any other match score (whether for another rotational position at the same alignment point or for any rotational position at any other alignment point).

As noted above, the method 700 described an approach in which a hypothetical grid was traversed using a “mowing the lawn” type algorithm. The starting points and directions of traversal of the hypothetical grid are of course arbitrary, and may be changed without departing from the scope of the present disclosure. Moreover, in an alternative embodiment, with suitable modification to the method 700, a spiral algorithm starting approximately in the center of the grid and traversing the grid elements in an outward spiral, may also be used.

With reference now to FIG. 8, an illustrative method for determining the best rotational match score for a given rotational position is shown generally at 800. Thus, the method 800 is an illustrative implementation of step 706 in FIG. 7.

At step 802, the current best interim rotational match score for the current rotational position is set to an arbitrary value “M”. The value “M” is an initialization value, and is set to represent a very poor rotational match between the questioned artwork and the target artwork. The exact value will depend of the particular scale of the match score, which in the illustrative method 800 depends on the image resolution. At step 804, the interim rotational match score is initialized to zero, and at step 806, the respective image positions are initialized so that the voxels within a chosen region in each image are properly aligned, and the comparison begins at the start voxel. Although the questioned surface region image and the target surface region image may not be aligned with one another (see method 700 above), the alignment will be such that at least the chosen regions overlap, and it is the chosen regions in respect of which the voxels are compared. In one embodiment, for example, the comparison begins at the lower leftmost voxel of the overlapping chosen region.

At step 806, the method 800 determines the difference between the Z-value of the current voxel in the questioned surface region image and the Z-value of the corresponding current voxel in the target surface region image. In one embodiment, signed values for the difference are used to track whether the voxel in the questioned surface region image is lower or higher than the corresponding voxel in the target surface region image; in an alternative embodiment absolute values of the difference may be used.

From step 806, the method proceeds to step 808, at which the Z-value difference is added to the interim rotational match score. Where signed values are used, negative values should be distinguished from positive values to avoid adverse effects on the accuracy of the resulting interim rotational match score. For example, the interim rotational match score may be a 1×2 matrix, with one element containing the sum of all negative differences and the other containing the sum of all positive differences. Where absolute values are used, the interim rotational match score can be a single number representing the sum of absolute differences in Z-values across all voxels.

At step 810, the method 800 checks whether the X-shift has finished, that is, whether there are any further voxels to the right in the overlapping chosen region of the questioned surface region image and the target surface region image. Responsive to a “no” determination at step 810, the method 800 proceeds to step 812 and shifts rightwards by one voxel in the X-direction (i.e. moves to the next pair of corresponding voxels to be compared), and then returns to step 806. Responsive to a “yes” determination at step 810, meaning that one complete row of voxels in the overlapping chosen region of the questioned surface region image and the target surface region image has been traversed, the method 800 proceeds to step 814.

At step 814, the method 800 checks whether the Y-shift is finished, that is, whether all rows in the overlapping chosen region in the questioned surface region image and the target surface region image have been traversed. Responsive to a “no” determination at step 814, the method 800 proceeds to step 816 to shift upward one voxel in the Y-direction and reset the X-value (i.e. move to the beginning of the next row), and then returns to step 806. Responsive to a “yes” determination at step 810, meaning that all of the rows in the overlapping chosen region of the questioned surface region image and the target surface region image have been traversed, the method 800 proceeds to step 818.

At step 818, the method 800 checks whether the interim rotational match score (i.e. the score for the current rotational position) is better than the current best interim rotational match score. As indicated above, the nature of the test will depend on the manner in which the match score is calculated. For example, where the absolute value of the difference between each set of two corresponding voxels is cumulated to obtain the interim rotational match score, a lower score would indicate a better match. In other embodiments, other tests may be used. Responsive to a “no” determination at step 818, the method 800 proceeds directly to step 822, and, responsive to a “yes” determination, at step 820 the method 800 sets the best interim rotational match score equal to the interim rotational match score (that is, the match score for the current rotational position) before proceeding to step 822.

At step 822, the method 800 checks whether rotation has finished, i.e. whether the questioned surface region image has been rotated relative to the target surface region image through a complete 360 degrees. Responsive to a “no” determination at step 822, the method 800 proceeds to step 824 at which the questioned surface region image is rotated one increment (e.g. one degree or optionally less than one degree) relative to the target surface region image and then returns to step 804. Responsive to a “yes” determination at step 822, meaning that all rotational positions have been tested, the method 800 proceeds to step 826 and returns the current best interim rotational match score.

As noted above, the method 800 described an approach in the Z-value of the voxels in the overlapping chosen region was compared, voxel-by-voxel, using a “mowing the lawn” type algorithm. The starting points and directions of traversal are of course arbitrary, and may be changed without departing from the scope of the present disclosure. Moreover, any suitable algorithm for comparing corresponding voxels may be used without departing from the scope of the present disclosure.

For example, and without limitation, it is contemplated that comparisons between questioned surface region images and the corresponding target surface region images may be carried out using methodologies developed via directed or undirected machine learning or other types of artificial intelligence systems. Such systems could produce, for example, a percentage match between a questioned surface region image and the corresponding target surface region image.

The present technology may be embodied within a system, a method, a computer program product or any combination thereof. The computer program product may include a computer readable storage device or media having computer readable program instructions thereon for causing a processor to carry out aspects of the present technology. The computer readable storage device can be a tangible device that can retain and store instructions for use by an instruction execution device. The computer readable storage device may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage device includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage device, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage device or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage device within the respective computing/processing device.

Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage device that can direct a computer, other programmable data processing apparatus, or other devices to function in a particular manner, such that the instructions stored in the computer readable storage device produce an article of manufacture including instructions which implement aspects of the functions/acts specified in the flowchart and/or block diagram block or blocks. The computer readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

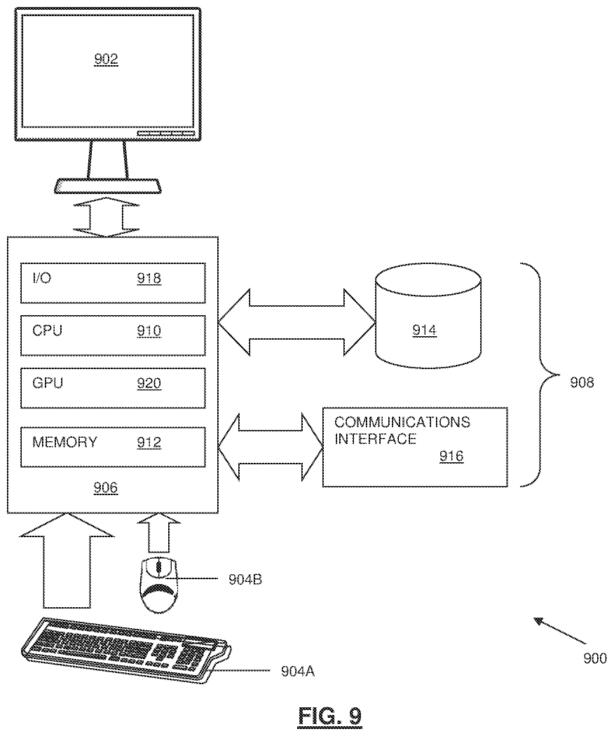

An illustrative computer system in respect of which the technology herein described may be implemented is presented as a block diagram in FIG. 9. The illustrative computer system is denoted generally by reference numeral 900 and includes a display 902, input devices in the form of keyboard 904A and pointing device 904B, computer 906 and external devices 908. While pointing device 904B is depicted as a mouse, it will be appreciated that other types of pointing device, or a touch screen, may also be used.

The computer 906 may contain one or more processors or microprocessors, such as a central processing unit (CPU) 910. The CPU 910 performs arithmetic calculations and control functions to execute software stored in an internal memory 912, preferably random access memory (RAM) and/or read only memory (ROM), and possibly additional memory 914. The additional memory 914 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, quantum storage, biological storage, or similar storage media as known in the art or hereafter developed. This additional memory 914 may be physically internal to the computer 906, or external as shown in FIG. 9, or both.

The computer system 900 may also include other similar means for allowing computer programs or other instructions to be loaded. Such means can include, for example, a communications interface 916 which allows software and data to be transferred between the computer system 900 and external systems and networks. Examples of communications interface 916 can include a modem, a network interface such as an Ethernet card, a wireless communication interface, or a serial or parallel communications port. Software and data transferred via communications interface 916 are in the form of signals which can be electronic, acoustic, electromagnetic, optical or other signals capable of being received by communications interface 916. Multiple interfaces, of course, can be provided on a single computer system 900.

Input and output to and from the computer 906 is administered by the input/output (I/O) interface 918. This I/O interface 918 administers control of the display 902, keyboard 904A, external devices 908 and other such components of the computer system 900. The computer 906 also includes a graphical processing unit (GPU) 920. The latter may also be used for computational purposes as an adjunct to, or instead of, the (CPU) 910, for mathematical calculations.

The various components of the computer system 900 are coupled to one another either directly or by coupling to suitable buses.

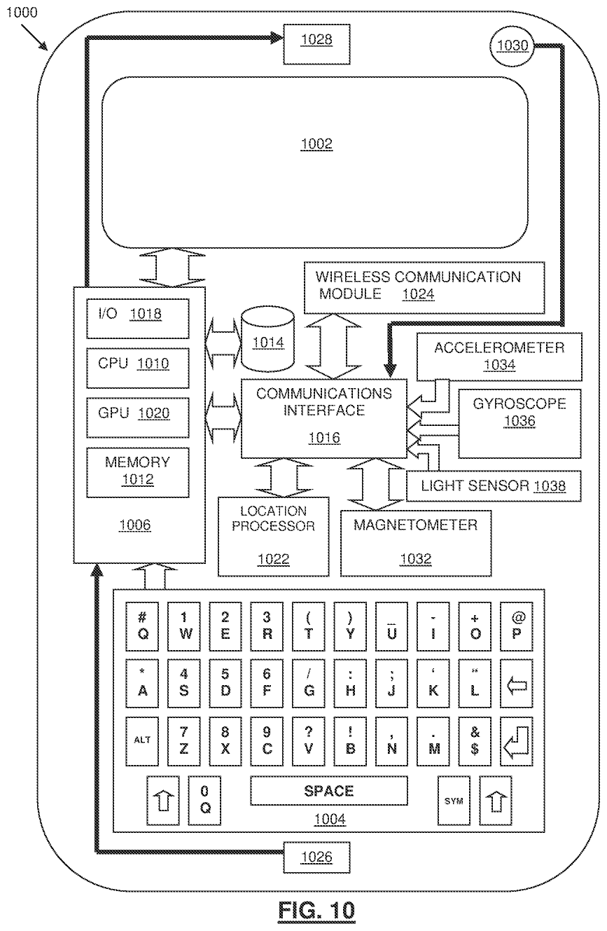

FIG. 10 shows an illustrative networked mobile wireless telecommunication computing device in the form of a smartphone 1000. The smartphone 1000 includes a display 1002, an input device in the form of keyboard 1004 and an onboard computer system 1006. The display 1002 may be a touchscreen display and thereby serve as an additional input device, or as an alternative to the keyboard 1004. The onboard computer system 1006 comprises a central processing unit (CPU) 1010 having one or more processors or microprocessors for performing arithmetic calculations and control functions to execute software stored in an internal memory 1012, preferably random access memory (RAM) and/or read only memory (ROM) is coupled to additional memory 1014 which will typically comprise flash memory, which may be integrated into the smartphone 1000 or may comprise a removable flash card, or both. The smartphone 1000 also includes a communications interface 1016 which allows software and data to be transferred between the smartphone 1000 and external systems and networks. The communications interface 1016 is coupled to one or more wireless communication modules 1024, which will typically comprise a wireless radio for connecting to one or more of a cellular network, a wireless digital network or a Wi-Fi network. The communications interface 1016 will also typically enable a wired connection of the smartphone 1000 to an external computer system. A microphone 1026 and speaker 1028 are coupled to the onboard computer system 1006 to support the telephone functions managed by the onboard computer system 1006, and a location processor 1022 (e.g. including GPS receiver hardware) may also be coupled to the communications interface 1016 to support navigation operations by the onboard computer system 1006. One or more cameras 1030 (e.g. front-facing and/or rear facing cameras) may also be coupled to the onboard computer system 1006, as may be one or more of a magnetometer 1032, accelerometer 1034, gyroscope 1036 and light sensor 1038. For example, where the smartphone 1000 is used to control the artwork authentication system 100, the camera(s) 1030 may be used to capture a digital image of the artwork. Input and output to and from the onboard computer system 1006 is administered by the input/output (I/O) interface 1018, which administers control of the display 1002, keyboard 1004, microphone 1026, speaker 1028, camera 1030, magnetometer 1032, accelerometer 1034, gyroscope 1036 and light sensor 1038. The onboard computer system 1006 may also include a separate graphical processing unit (GPU) 1020. The various components are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

Thus, computer readable program code for implementing aspects of the technology described herein may be contained or stored in the memory 1012 of the onboard computer system 1006 of the smartphone 1000 or the memory 912 of the computer 906, or on a computer usable or computer readable medium external to the onboard computer system 1006 of the smartphone 1000 or the computer 906, or on any combination thereof.

Finally, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope of the claims. The embodiment was chosen and described in order to best explain the principles of the technology and the practical application, and to enable others of ordinary skill in the art to understand the technology for various embodiments with various modifications as are suited to the particular use contemplated.

One or more currently preferred embodiments have been described by way of example. It will be apparent to persons skilled in the art that a number of variations and modifications can be made without departing from the scope of the claims. In construing the claims, it is to be understood that the use of a computer to implement the embodiments described herein is essential.

What is claimed is the following:

1. A computer-implemented method for authenticating an artwork, comprising:
obtaining identifying information for the artwork, the identifying information including at least an artwork identifier and dimensions of the artwork;
determining a set of surface regions, each surface region being a portion of an overall surface of the artwork, and coordinate information identifying and locating each surface region relative to the overall surface;
obtaining a three-dimensional topographical image of each surface region; and
storing the identifying information, the coordinate information and the topographical images so that the coordinate information and the topographical images are associated with the artwork identifier and each topographical image is associated with its corresponding coordinate information.

2. The method of claim 1, wherein the set of surface regions is randomly generated.

3. The method of claim 1, wherein the set of surface regions is determined based on a formula using at least one parameter of the artwork as input.

4. The method of claim 1, wherein the three-dimensional topographical image of each surface region is obtained using an interferometer.

5. The method of claim 1, further comprising storing environmental condition information for the three-dimensional topographical image of each surface region.

6. The method of claim 5, wherein the environmental condition information includes at least one of relative humidity, temperature and barometric pressure for an environment in which the artwork is located when obtaining the three-dimensional topographical image of each surface region.

7. The method of claim 1, further comprising, before storing the identifying information, the coordinate information and the topographical images:
obtaining environmental condition information for the three-dimensional topographical image of each surface region; and
using the environmental condition information to standardize the three-dimensional topographical image of each surface region.

8. The method of claim 7, wherein the environmental condition information includes at least one of relative humidity, temperature and barometric pressure for an environment in which the artwork is located when obtaining the three-dimensional topographical image of each surface region.

9. The method of claim 1, wherein obtaining the three-dimensional topographical image of each surface region is done in standardized environmental conditions.

10. A computer-implemented method for authenticating an artwork, comprising:
providing a questioned artwork purporting to be a target artwork;
retrieving, for the target artwork, coordinate information identifying and locating each of a plurality of target surface regions of an overall surface of the target artwork; and
using the coordinate information to obtain a three-dimensional topographical image of each of a plurality of questioned surface regions of an overall surface of the questioned artwork, each questioned surface region corresponding in its location on the overall surface of the questioned artwork to a location of a corresponding one of the target surface regions of an overall surface of the target artwork.

11. The method of claim 10, wherein the three-dimensional topographical image of each of the plurality of questioned surface regions is obtained using an interferometer.

12. The method of claim 10, further comprising:
comparing each three-dimensional topographical image of a questioned surface region to a three-dimensional topographical image of a correspondingly located target surface image on the target artwork.

13. The method of claim 12, further comprising:
obtaining questioned artwork environmental condition information for the three-dimensional topographical image of each of the plurality of questioned surface regions; and
retrieving target artwork environmental condition information for each three-dimensional topographical image of a correspondingly located target surface image on the target artwork;
wherein comparing each three-dimensional topographical image of the questioned surface region to the three-dimensional topographical image of the correspondingly located target surface image on the target artwork accounts for differences between the questioned artwork environmental condition information and the target artwork environmental condition information.

14. The method of claim 13, wherein the environmental condition information includes at least one of relative humidity, temperature and barometric pressure for an environment in which the artwork is located when obtaining the three-dimensional topographical image of each surface region.

15. The method of claim 10, further comprising:
obtaining environmental condition information for the three-dimensional topographical image of each of the plurality of questioned surface regions; and
using the environmental condition information to standardize the three-dimensional topographical image of each of the plurality of questioned surface regions.

16. The method of claim 15, wherein the environmental condition information includes at least one of relative humidity, temperature and barometric pressure for an environment in which the artwork is located when obtaining the three-dimensional topographical image of each surface region.

17. The method of claim 10, wherein obtaining the three-dimensional topographical image of each of the plurality of questioned surface regions is done in standardized environmental conditions.
